(19) United States
(12) Patent Application Publication
(10) Pub. No.: US 2007/0067274 A1
(43) Pub. Date: Mar. 22, 2007

(54) Hybrid push-down/pull-up of unions with expensive operations in a federated query processor

(75) Inventors: Wei Han, San Francisco, CA (US); Inderpal S. Narang, Saratoga, CA (US); Vijayshankar Raman, San Jose, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/228,888

(22) Filed: Sep. 16, 2005

(51) Int. Cl. G06F 17/30

(52) U.S. Cl. 707/4

(57) ABSTRACT

Disclosed are a method and a system for executing a query that requires an expensive process, such as a join, between two or more datasets. If each dataset has multiple partitions that are located at multiple sources, then each of the multiple partitions for each dataset must be unioned prior to completing execution of the query. The method and system develop both a query execution plan and at least one alternative query execution plan to indicate when the process should be pushed down below the unions and when the process should be pulled up above the unions based on collocation of partitions. The query execution plan and the alternative query execution plan(s) are embedded in a composite query execution plan which is evaluated and re-evaluated at run time to determine which of the query execution plan and the alternative query execution plan is currently the most efficient plan and the query is executed, accordingly.

### BACKGROUND OF THE INVENTION

1. Field of the Invention

The embodiments of the invention generally relate to processing database queries, and, more particularly, to a method and system of processing queries in a federated query processor that incorporates hybrid push-down/pull-up of union operations while still preserving all opportunities for collocating expensive operations.

2. Description of the Related Art

Partitioned tables are a very common data layout used to achieve scalability in query processing. This invention concerns expensive operations such as joins, sorts, hashes, grouped bys, etc., over such partitioned tables. For example, a join ( [symbol] ) of two logical domains (e.g., Orders (O) and Customers (C)) comprises a union of all partitions of Orders (e.g., O1, O2 and O3) joined with a union of all partitions of Customers (e.g., C1, C2, and C3), as described below:
O [symbol] C=(O1 U O2 U O3) [symbol] (C1 U C2 U C3)

Each partition (e.g., O1-O3 and C1-C3) is maintained on the same or different servers. One method of completing such an expensive operation first unions all partitions in each logical domain using separate operators communicating with the different servers and then performs the join of each logical domain using a central processor communicating with the separate operators. The drawback with this method is that it does not exploit the processing power of the remote servers for the expensive join operation. In particular, if partitions from the different logical domains are collocated on the same server, it makes sense to push down their join below the union, both to avoid network transfer and to spread the join work across two nodes (i.e., the remote server and the central processor). Such exploitation is especially important in a federated information system because in this architecture, one central query processor handles queries over a large number of data sources. If the bulk of the work for each query is done at the central query processor, it will very rapidly become overloaded and cause performance degradation. To avoid overloading the central query processor, another method of performing this partitioned join is to push down as much of the query processing work as possible to the servers where the data is located. In particular, these remote servers handle partitioned joins, as described above, by expanding the cross-product and pushing done all joins below the union. However, this method results in a multiplicative explosion of joins and burdens the central processor with the load of these multiple joins. Therefore, there is a need for a method and system of processing queries in a federated database management system that incorporates a hybrid push-down/pull-up scheme for unions to preserve all opportunities for collocated expensive operations, while keeping the total number of expensive operations performed small.

### SUMMARY OF THE INVENTION

In view of the foregoing, an embodiment of the invention provides a method and an implementing system for executing a query in a database management system (e.g., a federated database management system), where the query requires a process, such as an expensive operation with multiple cycles (e.g., a join, a sort, a hashing or a group-by) between two or more datasets (i.e., logical domains). If each dataset has multiple partitions located at multiple sources (e.g., servers, processors, data storage devices within servers, machines, etc.), then each of the multiple partitions for each dataset must be unioned prior to completing execution of the query. The method and system use a hybrid scheme to develop a query execution plan that indicates when a process (e.g., joins, sorts, group-bys, etc.) should be pushed down below the unions and when the process should be pulled up above the unions based on collocation of partitions. Thus, the method and system exploit collocated partitioning to the extent it is available but does not rely on completely identical partitioning of datasets. The method and system can further be used to develop at least one alternative query execution plan. The query execution plan and the alternative query execution plan can be embedded into a composite query execution plan and dynamically evaluated and re-evaluated for efficiency based on estimated processor costs, time consumptions, processor loads, the availability of various system components, etc. Thus, the method and system can ensure that the most efficient query execution plan is used to execute the query.

More particularly, a primary operator (e.g., a primary meta-wrapper) is used to receive from an optimizer a query for performing a process, such as an expensive operation requiring multiple cycles (e.g., a join, a sort, a hashing, a group-by, etc.), between multiple datasets or logical domains (e.g., a first dataset, a second dataset and, optionally, additional data sets). If each dataset has multiple partitions located at multiple sources (e.g., servers, processors, data storage devices within servers, machines, etc.), then each of the multiple partitions for each dataset must be unioned prior to completing execution of the query.

In order to develop the query execution plan, the primary operator accesses a directory (e.g., a data repository) listing all of the partitions for all of the datasets as well as the source locations for each partition. For example, the directory may include a list of the first partitions of the first dataset, the second partitions of the second dataset, and the sources where each of the first partitions and each of the second partitions are located. The primary operator uses the directory to identify the partitions for each dataset and to determine which of the partitions from the different datasets are collocated on the same source and which are not. The primary operator may also use the directory to determine which of the first partitions and the second partitions are unrelated, so as to eliminate the unrelated partitions from a query execution plan. For example, the primary operator can determine whether the partitioned data are unrelated and, therefore, which partitions do not need to undergo the given process (e.g., a join).

After accessing the directory and determining the source locations for the various partitions, the primary operator develops a query execution plan based on collocation of the partitions. Specifically, the primary operator determines an order for unioning of the datasets and for performing the processes, such as the joins, sorts, etc. based on collocation of the partitions. For example, the query execution plan can provide that if a first partition is collocated with a second partition on a same source and the same source has a query processor, then the process (e.g., a join) is performed between the first partition and the second partition by the query processor of that same source. This process (e.g., the join) is performed prior to performing a union of the first partition with any other first partitions and prior to performing a union of the second partition with any other second partitions. In other words the processing of collocated partitions is pushed down below the union to the same source (e.g., the same remote server) on which they are collocated.

Also, if an additional first partition is located on a different source from an additional second partition, then the additional first partition and the additional second partition are processed (e.g., joined) after unioning the additional first partition with any other first partition and/or after unioning the additional second partition with any other second partition. In other words the processing of non-collocated partitions is pulled up above the union to an additional query processor.

After developing the query execution plan, the primary operator determines alternatives to the query execution plan (i.e. at least one alternative query execution plan). Each alternative to the query execution plan indicates another order for unioning the partitions within each dataset and for performing the process between the different datasets.

The primary operator can further be adapted to convert the query execution plan and the alternative query execution plan(s) into a query language (e.g., standard query language (SQL), Xquery, etc.) and embed all of the plans into a composite query execution plan. The primary operator can then return the composite query execution plan to the optimizer which can be adapted to evaluate the embedded plans based on estimated processing times, estimated processor costs, estimated processor loads and/or estimated component availability, to determine which plan is most efficient and, thereby, which should be used to execute the query.

At run time the optimizer can forward the composite query execution plan to one or more secondary operators (e.g., via the primary operator and one or more additional query processors) and also to the query processor of the same source (e.g., same remote server) where a first partition and a second partition are collocated. The composite query execution plan may recommend the most efficient plan as determined by the optimizer. However, since the query execution plan and the alternative query execution plan are both embedded in the composite query execution plan, each of the individual secondary operators (or, optionally, the additional query processors) can be adapted to dynamically re-evaluate each of the plans to determine which is currently the most efficient and to execute the query, accordingly.

In order to execute the query, the secondary operators are each in communication with different sources (e.g., different remote servers) and are adapted to union the multiple partitions for a particular dataset that are located on the different sources. For example, a secondary operator can be adapted to union a group of first partitions for the first dataset and another secondary operator can be adapted to union a group of second partitions for the second dataset. The unioned partitions can then be sent from the secondary operators to a corresponding additional query processor where they are processed (e.g., joined, sorted, etc. as indicated by the query) with either a single partition from another dataset or a union of partitions from another dataset). Once all of the processing (e.g., joining) is completed (e.g., by the query processor of the same source and by the additional query processors), the processed non-unioned partitions from the same source and the processed unioned partions from each of the additional query processors are sent to the primary operator for completing the union between the different datasets.

These and other aspects of embodiments of the invention will be better appreciated and understood when considered in conjunction with the following description and the accompanying drawings. It should be understood, however, that the following description, while indicating embodiments of the invention and numerous specific details thereof, is given by way of illustration and not of limitation. Many changes and modifications may be made within the scope of the embodiments of the invention without departing from the spirit thereof, and the invention includes all such modifications.

### BRIEF DESCRIPTION OF THE DRAWINGS

The embodiments of the invention will be better understood from the following detailed description with reference to the drawings, in which:

FIG. 1 is a schematic diagram illustrating a query system;

FIG. 2 is a schematic diagram illustrating another query scheme;

FIG. 3 is a schematic flow diagram illustrating an embodiment of the method of the invention;

FIG. 4 is a schematic diagram illustrating an embodiment of the query system of the invention;

FIG. 5 is a schematic diagram of an exemplary data repository of FIG. 4, and FIG. 6 is a schematic diagram of an exemplary bipartite graph.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the invention.

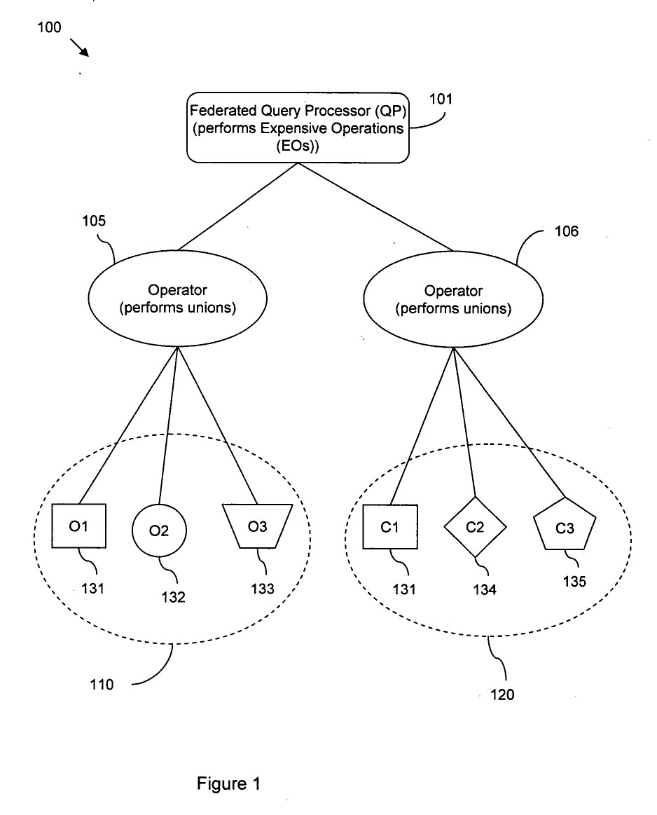

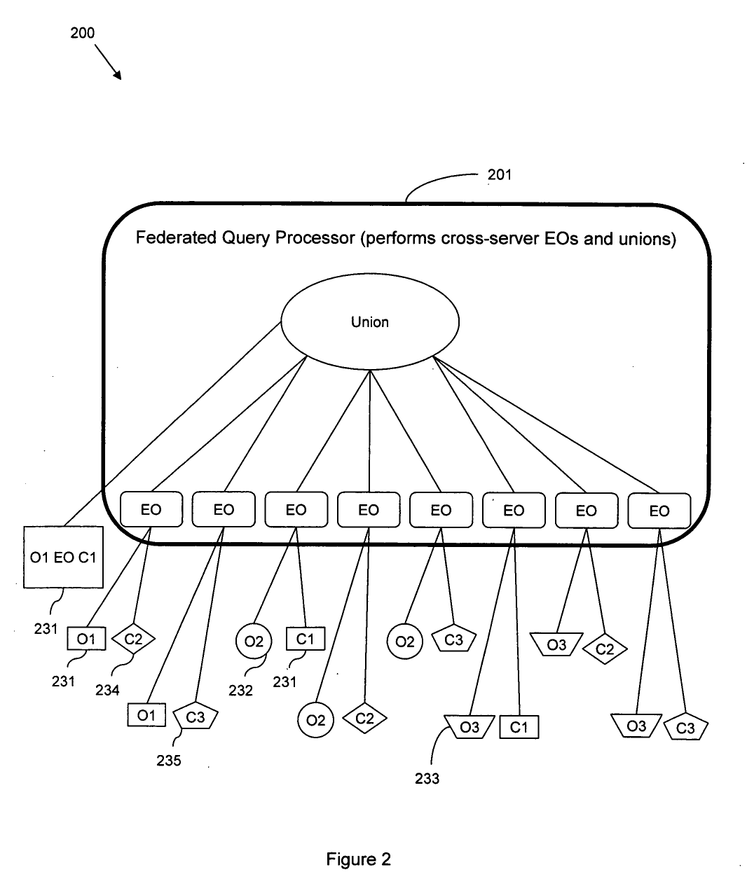

Partitioned tables are a very common data layout used to achieve scalability in query processing. This invention concerns expensive multiary operations such as joins, sorts, hashes, grouped bys, etc., over such partitioned tables maintained in different locations (e.g., databases on different servers, on different data storage devices, on different data storage devices on the same server, etc.). More particularly, this invention concerns a method and system of processing queries in a database management system that incorporates hybrid push-down/pull-up of unions to preserve all opportunities for collocated expensive operations, while keeping the total number of expensive operations performed small. For example, referring to FIGS. 1 and 2, a join ( [symbol] ) of two logical domains (e.g., Orders (O) and Customers (C)) comprises a union of all partitions of Orders (e.g., O1, O2 and O3) times a union of all partitions of Customers (e.g., C1, C2, and C3), as described below:
O [symbol] C=(O1 U O2 U O3)×(C1 U C2 U C3)

Each partition (e.g., O1-O3 and C1-C3) is maintained on the same or different servers. As illustrated in FIGS. 1 and 2, each shape represents a different server, e.g., the O1 and C1 partitions are located on the same server that is represented by a square, the O2 partition is located on a different server that is represented by a circle, and so on.

As mentioned above and illustrated in FIG. 1, one method and system 100 of performing this partitioned join (or another expensive operation) is to union all partitions O1-O3 and C1-C3 for each logical domain 110 and 120, respectively, with a corresponding operator 105 and 106, respectively. Then, the unioned partitions for each logical domain 110, 120 are forwarded to a federated query processor 101, where the join is performed. The union operators 111, 121 can comprise meta-wrappers adapted to union all data items from all the tables in a given logical domain and dynamically detects the available partitions for a table at query execution time. Using a query execution plan, the federated query processor, fetches the data from the five different servers 131-135, via the unioning operators 111, 121, and performs the join. The drawback with this method is that it does not exploit the processing power of the remote servers 131-135 for the expensive join operations. In particular, since O1 and C1 are collocated on the server 131 (i.e., the square node), it makes sense to push down their join below the union, both to avoid network transfer and to spread the join work across two nodes (i.e., the square node 131 and the central query processor 100). Such exploitation is especially important in a federated information system because in this architecture, one central query processor 100 handles queries over a large number of data sources. If the bulk of the work for each query is done at the central query processor 100, it will very rapidly become overloaded and cause performance degradation.

As mentioned above and illustrated in FIG. 2, to avoid overloading the central query processor, another method and system 200 for performing this partitioned join is to push down as much of the query processing work as possible to the remote servers where the data is located. In particular, this other method handles partitioned joins or other expensive operations, such as those described above, by expanding the cross-product and pushing done all joins below the union. Referring to FIG. 2, this method allows partitions (e.g., O1 and C1) from different logical domains that are collocated on the same server 231 (i.e., the square node) to be joined by that same server 231, but also results in a multiplicative explosion of cross-node joins (i.e., joins of partitions located on different servers). For example, if O [symbol] C=(O1 U O2 U O3)×(C1 U C2 U C3), then there are nine joins (e.g., (O1 [symbol] C1) U (O1 [symbol] C2) U (O1 [symbol] C3) U (O2 [symbol] C1) U . . . , and so on). Since only C1 and O1 are collocated on the same server 231, then there are eight cross-node joins which are performed by the federated query processor 201. Once each of the nine joins is performed, the federated query processor 201 performs the unions. One problem with this method of pushing down all joins below the unions is that it creates such a large number of expensive joins because each of the partitions is transferred across the network three times and joined three times. Another problem with this method is that the central federation node is burdened with the load of eight out of nine joins. Thus, the challenge is to push down as much of the query processing as possible to the remote servers housing the data, while still keeping the total number of joins performed small and performing all the local joins (where both partitions are collocated on the same server) on the node where the inputs are located.

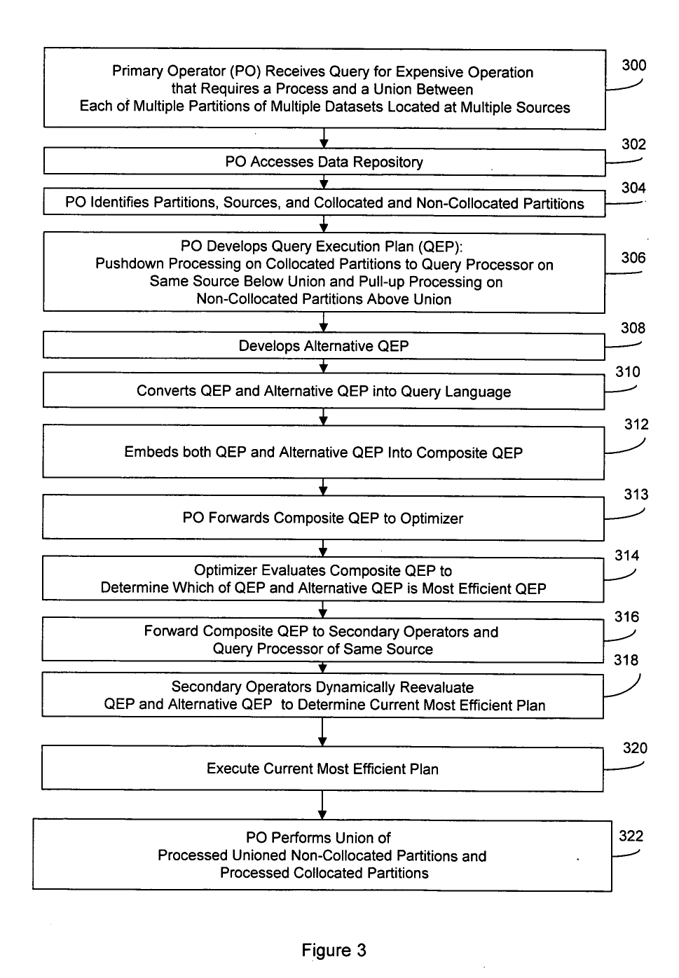

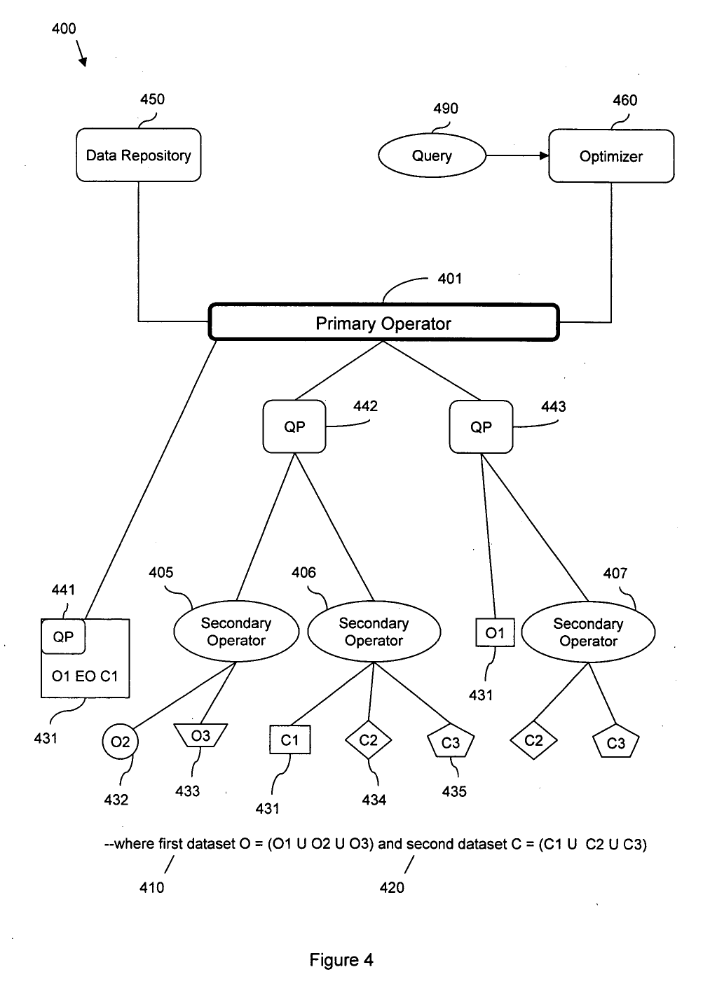

In view of the foregoing, an embodiment of the invention provides a method (as illustrated in the flow diagram of FIG. 3) and an implementing system 400 (as illustrated in FIG. 4) for executing a query in a database management system (e.g., a federated database management system), where the query requires a process, such as an expensive operation having multiple cycles (e.g., a join, a sort, a hashing or a group-by) between two or more datasets 410, 420 (i.e., logical domains). If each dataset 410, 420 has multiple partitions located at multiple sources (e.g., servers, processors, data storage devices within servers, machines, etc.), then each of the multiple partitions for each dataset must be unioned prior to completing execution of the query. The method uses a hybrid scheme (i.e., a hybrid execution plan) to develop a query execution plan that indicates when a process (e.g., a join, a sort, a group-by, etc.) should be pushed down below the unions and when the process should be pulled up above the unions based on collocation of partitions. Thus, the method exploits collocated partitioning to the extent it is available but does not rely on completely identical partitioning of datasets. The method further provides alternatives to the query execution plan and executes the query using either the query execution plan or the alternatives based on an efficiency evaluation, including an evaluation of estimated processor costs, time consumptions, processor loads, the availability of various system components, etc.

Referring to FIGS. 3 and 4 in combination, the method and implementing system 400 comprise using a primary operator 401 (e.g., a meta-wrapper, an type of other union operator, etc.) to receive a query 490 from an optimizer 460. The query 490 requires a process, such as an expensive operation requiring multiple cycles (e.g., a join, a sort, a hashing, a group-by, etc.) between multiple datasets or logical domains (see process 300). For example, the query 490 may require joins between a first dataset 410, a second dataset 420 and, optionally, additional data sets, as illustrated in an exemplary embodiment describe below. A logical domain or dataset (e.g., 410, 420) is the set of all data sources and replicas that provide similar information, and have a schema mapping to a common logical domain schema. For example, a logical domain 420 of customers (C) can comprise multiple partitions (e.g., C1, C2 and C3) from multiple data sources (e.g., data sources 431, 434, 435) and one or more of the partitions can have replica sources. If each dataset has multiple partitions that are located at multiple sources (e.g., servers, processors, data storage devices within servers, machines, etc.), then each of the multiple partitions for each data set must be unioned prior to completing execution of the query.

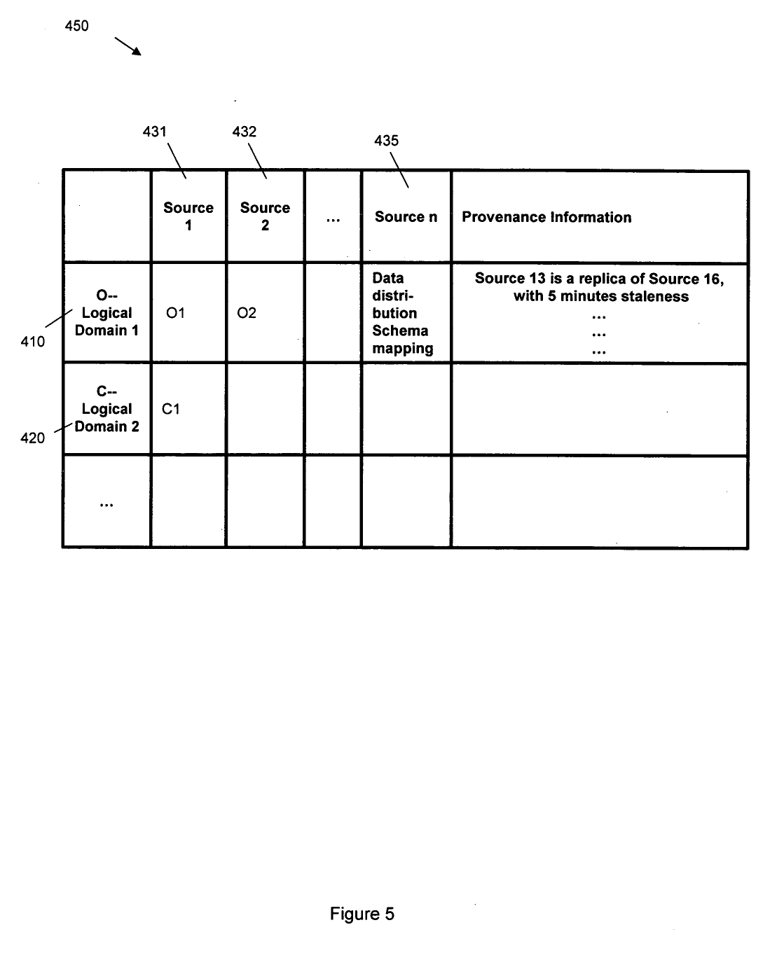

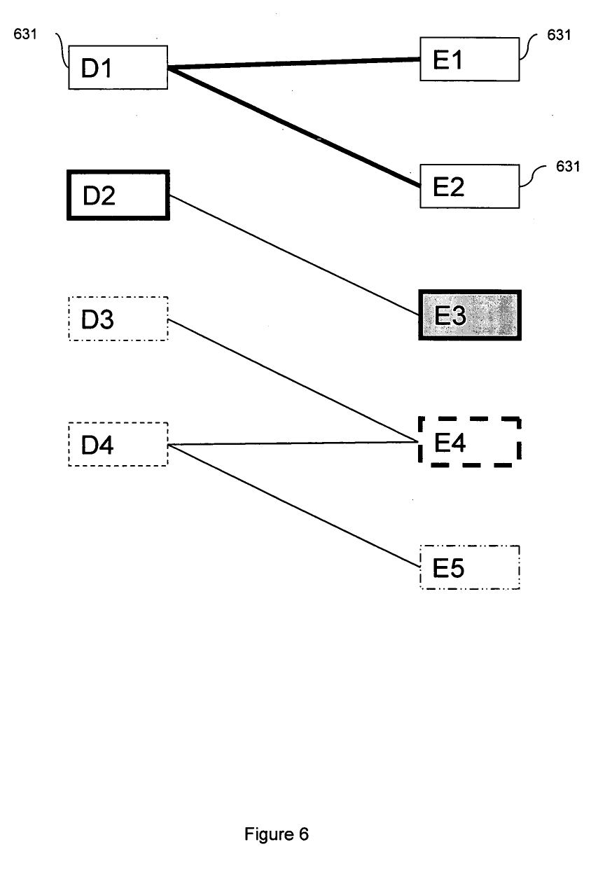

It should be noted that exemplary embodiments of the method and system 400 are described herein in the context of using wrapper modules, such as meta-wrappers (e.g., as disclosed in U.S. patent application Ser. No. 10/931,002, Narang et al., filed Aug. 31, 2004, and incorporated herein by reference) to perform the functions of the primary operator 401 and secondary operators 405-407, discussed below. Specifically, a meta-wrapper is a wrapper that encapsulates all data sources and replicas for a logical domain, and makes them appear to the query processor as a single source. The meta-wrapper's primary role is late binding of data sources to the logical domain. Application programs access the data by specifying only the domain (e.g., select id, name from Customers, where salary>150000). During optimization, the query optimizer 460 pushes down to the primary meta-wrapper query fragments that involve a logical domain (e.g., 410 or 420). The primary meta-wrapper then contacts an external meta-data repository 450, such as that described in Narang et al., with the logical domain 410, 420, the query predicates and the query's quality of service (QOS) constraints (e.g., the query's tolerance for stale data), in order to determine the set of sources/replicas (e.g., 431-435) that have relevant information for this query (see FIG. 5). The primary meta-wrapper then sends query fragments (after schema translation) to the secondary meta-wrappers (i.e., the secondary operators 405-405) for the actual data sources/replicas 431-435, and gets query fragment execution plans over each of the query fragments. The primary meta-wrapper then generates a query execution plan by combining the query fragment execution plans returned from each of the secondary meta-wrappers for each of the data sources/replicas. At runtime, the primary meta-wrapper behaves like a union operator that merges the tuples from each of the source wrappers. The primary meta-wrapper also substitutes sources with replicas (or vice-versa) upon failures. While embodiments of the invention are described herein in terms of using a meta-wrapper to perform the functions of the primary operator 401 and secondary operators 405-407, those skilled in the are will recognize that such meta-wrappers are only offered as exemplary devices that may be used to implement the method and system of the invention and that other devices, for example, the query optimizer 400 or a query executor may also be adapted to perform these same functions. However, a drawback to the optimizer-only implementation is that the allocation of plan fragments to compute nodes is made before the query begins executing.

Again referring to FIGS. 3 and 4 in combination, in order to develop the query execution plan (at process 306), the primary operator 401 can be adapted to access a directory 450 (e.g., a data repository) that lists all of the partitions for all of the datasets 410, 420 as well as the source locations 431-435 for each partition (e.g., O1-O3 and C1-C3) (see process 302 and FIG. 5). For example, the directory 450 may include a list of the first partitions O1-O3 of the first dataset of orders (O) 410, the second partitions C1-C3 of the second dataset of customers (C) 420, and the sources 431-435 (e.g., servers, processors, data storage devices within servers, machines, etc.) where each of the first partitions and each of the second partitions are located. The primary operator 401 uses the directory 450 to identify the partitions (e.g., O1-O3 and C1-C3) for each dataset 410, 420 and to determine which of the partitions from the different datasets are collocated on the same source (e.g., 431) and which are not (see process 304). The primary operator 401 may also use the directory 450 to determine which of the first partitions and the second partitions are unrelated, so as to eliminate the unrelated partitions from a query execution plan. For example, the primary operator 401 can determine whether the partitioned data are unrelated and therefore, do not need to undergo the given query process (e.g., a join).

After accessing the directory (at process 302) and determining the source locations for the various partitions (at process 304), the primary operator 401 can be adapted to develop a query execution plan that indicates a recommended or preferred order for performing the processes (e.g., joins, sorts, etc.) between the different datasets and for performing the unions between the multiple partitions of each dataset, based on collocation and non-collocation of the partitions (see process 306). Specifically, the query execution plan can indicate that if a first partition of a first dataset 410 is collocated with a second partition of a second dataset 420 on a same source (e.g., partitions O1 and C1 on server 431) and the same source 431 has a query processor 441, then the first partition O1 and the second partition C1 should be processed (e.g., joined) by the query processor 441 of that same source 431. Processing by the same source 431 should occur prior to unioning the first partition O1 with other first partitions (e.g., O2 or O3) in that first dataset 410 and prior to unioning the second partition C1 with other second partitions (e.g., C2 or C3) in that second data set 420. In other words the processing of collocated partitions O1 and C1 is pushed down below the union at the primary operator 401 to the same source 431 (e.g., the same remote server) on which they are both located.

Also, if an additional first partition of the first dataset 410 is located on a different source from an additional second partition of the second dataset 420 (e.g., O2 located on server 432 and C2 located on server 434), then the additional first partition O2 and the additional second partition C2 are processed (e.g., joined) by additional query processors 442 or 443 (e.g., additional federated query processors) after unioning the additional first partition O2 with any other first partition (e.g., O1 or O3) in the first dataset 410 and/or after unioning the additional second partition C2 with any other second partition (e.g., C1 or C3) in the second dataset 420 by secondary operators (e.g., 405 and 406, respectively). In other words the processing of non-collocated partitions, such as O2 and C2, is pulled up to the additional query processors 442-443 above the union of partitions from the same data sets by secondary operators 405-407.

Additionally, the primary operator 401 can be adapted to determine alternatives to the query execution plan (i.e., at least one alternative query execution plans) (see process 308). An alternative query execution plan can indicate another order by which the unioning of the partitions within each dataset and the performing of the process (e.g., the join) between the different datasets that are located at the same and/or different sources can be accomplished.

The primary operator 401 can further be adapted to convert the query execution plan and the alternative query execution plan into a query language (e.g., standard query language (SQL), Xquery, etc.) (see process 310) and then embed both the query execution plan and the alternative into a composite query execution plan (see process 312). The primary operator 401 can be adapted to return the composite query execution plan to the optimizer 460 (see process 313). The optimizer 460 can be adapted to evaluate the query execution plan and the alternative query execution plan based on estimated processing times, estimated processor costs, estimated processor loads and/or estimated component availability, to determine which of the query execution plan and the alternative query execution plan is the most efficient and, thereby, which should be used to execute the query (see process 314).

At run time, the optimizer 460 can forward (e.g., via the primary operator 401 and one or more additional query processors 442-443) the composite query execution plan to one or more secondary operators 405-407 and to the query processor 441 of the same source 431 where a first partition O1 and a second partition C1 are collocated (see process 316). While the composite query execution plan can recommend a most efficient plan based on the evaluation by the optimizer (at process 314), both the query execution plan and the alternative query execution plan are embedded into the composite query execution plan so that each of the secondary operators 405-407 (i.e., secondary meta-wrappers) can dynamically re-evaluate the query execution plan and the alternative to determine which is currently the most efficient (see process 318) and to execute the current most efficient plan (see process 320). Thus, the secondary operators 405-407 can choose to run the cheapest process at that moment based on the time it takes to run the process, the charging scheme used, the current loads on the various servers, etc. Allowing the secondary meta-wrappers 405-407 to dynamically choose between the plan and at least one alternate plan avoids situations in which cost might be prohibitive and/or situations in which different processors may be out of services. While embodiments of the invention are described above with the secondary operators 405-407 being adapted to choose the most efficient plan, alternatively, choosing the most efficient plan may be left to the query processors 441-443.

Note that if the query processor 441 of source 431 is a federated query processor, then in addition to processing collocated partitions, the federated query processor 441 may be used to process partitions not located on the node 431. For example, processor 441 may join O1 [symbol] C1 as well as O1 [symbol] (C-C1), where C-C1 is equal to the logical domain C minus the partition C1.

As mentioned above, in order to execute the plan, the system 400 may comprise one or more secondary operators 405-407(e.g., secondary meta-wrappers) in communication with the additional query processors 442-443. The secondary operators 405-407 are also in communication with different sources 431-435 (e.g., different remote servers) and are adapted to union partitions for a particular dataset located on the different sources. For example, a secondary operator 405 can be adapted to union non-collocated first partitions (O2 and O3) for the first dataset 410 and another secondary operator 406 can be adapted to union non-collocated second partitions C1-C3 for the second dataset 420. Thus, unioned partitions (e.g., O2 U O3 and C1 U C2 U C3) are sent from the secondary operators 405 and 406 to a corresponding additional query processor 442 where they are processed (e.g., joined, sorted, etc. as indicated by the query) with each other. Similarly, a secondary operator 407 can union the second partitions C2 and C3 which are then processed with a single partition O1 by additional query processor 443. Once all of the processing (e.g., joining) is completed (e.g., by the query processor 441 of the same source and by the additional query processors), the processed non-unioned partitions from the same source 431 and the processed unioned partitions from each of the additional query processors 442-443 are sent to the primary operator 401 for completing the process (e.g., the join) between the datasets 410-420 (see process 322).

Embodiments of the system 400, as described above, can take the form of an entirely hardware embodiment, an entirely software embodiment or an embodiment including both hardware and software elements. In a preferred embodiment, the invention is implemented using software, which includes but is not limited to firmware, resident software, microcode, etc. Furthermore, embodiments of the system 400 can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The following is a description of one exemplary implementation of an embodiment of the method and system 400 of the invention, as illustrated in FIGS. 3 and 4, respectively. The exemplary embodiment is based on the idea of supporting a join of logical domains 410, 420 etc. within a single meta-wrapper 401. For example, a single meta-wrapper 401 is responsible for the following query:
O [symbol] C=(O1 U O2 U O3)×(C1 U C2 U C3)

The meta-wrapper 401, upon receiving the request (O [symbol] C) from the optimizer 460 (at process 300), contacts an external metadata repository 450 (at process 302) to find out the following information (at process 304): the identity of the partitions in each logical domain 410, 420 (e.g., O=(O1 U O2 U O3) and C=(C1 U C2 U C3)); the location (i.e., source) of each partition (e.g., O1 is located on source 431, O2 is located on source 432, O3 is located on source 433, C1 is located on source 431, C2 is located on source 434 and C3 is located on source 435); and the identity of collocated partitions (e.g., O1 and C1 are collocated on source 431). For illustration purposes, different sources are represented by different shapes in FIG. 3. Optionally, the meta-wrapper 401 may contact the directory 450 to determine whether the partitioning of O and C are identical in order to avoid creating cross-node joins. More generally, the metadata repository can tell the meta-wrapper 401 precisely which clauses of the expanded join (O1 U O2 U O3)×(C1 U C2 U C3) need to performed, and which vanish because they are unrelated and would, therefore, never be joined. The meta-wrapper 401 uses this information to carefully reorder the query (i.e., expand the join O [symbol] C=(O1 U O2 U O3)×(C1 U C2 U C3)), preserving all opportunities for collocated joins, while still avoiding a multiplicative explosion of joins by pushing down as many unions as possible below joins.

Specifically, FIG. 3 illustrates a hybrid pushdown scheme, with only the local join pushed down below the union. This method provides the advantage of exploiting the server 431, on which two partitions O1 and C1 are collocated, to do the local join, while still moving and joining the remaining partitions across the network only once. The meta-wrapper 401 contacts the metadata repository 450 (at process 302) and finds out the information listed above (at process 304). The meta-wrapper 401 uses this information to rewrite or reorder the query into a composite query execution plan, as follows, including a query execution plan and alternatives such that a query (O [symbol] C) @ 401 is reordered into a combination of unions and ors (‘|’s, where the ors provide the alternative query execution plans):
(O1 [symbol] C1 @ 431|O1 [symbol] C1 @ any) U
(O1 [symbol] (C-C1) @ 431|O1 [symbol] (C-C1) @ any) U
((O−O1) [symbol] C) @ any)

Thus, the meta-wrapper 401 has developed a new query execution plan by expanding the join of union O [symbol] C into three clauses: one for the collocated join (O1 [symbol] C1), and two other joins for the remainder. For the first two clauses (first clause O1 [symbol] C1 and second O1 [symbol] (C-C1)), the meta-wrapper 401 creates a reordered query execution plan and an alternative. The reordered query pushes the joins to the source node 431, where O1 resides. The first clause benefits from this pushdown because it becomes a local join. The second clause benefits because C-C1 can be directly sent to the source node 431 without going through a federated query processor node. The alternative order pushes the first clause O1 [symbol] C1 and second O1 [symbol] (C-C1)), down to an “any” node that stands for “any join processor node”. Lastly, for the third clause ((O−O1) [symbol] C) the meta-wrapper 401 creates only one plan, since there is no “interesting node” to push it down to. The meta-wrapper 401 does the pushdown to the “any” query processor by contacting other query processors recursively. It is implemented by reconverting the union arms into SQL (at process 312). For example, (O−O1) [symbol] C is written as “select * from O2, C UNION select * from O3, C”. In this exemplary embodiment, the meta-wrapper 401 uses the relational wrappers to process this SQL (e.g., the DRDA wrapper). At run-time, the relational wrapper contacts the query processor 441 on the remote node 431. The remote node 431 is also able to access other partitions because it is a federated query processor. Alternatively, if the remote node 431 is not a federated query processor, the meta-wrapper 401 can still push down the join computation to that remote node 431 by writing the access to O2, O3, all C partitions as table functions.

Therefore, by expanding O [symbol] C @ 401 the meta-wrapper 401 has generated four plans, including alternatives. These four plans are formed by taking the cross-product of the two first clauses, two second clauses, and the one third clause. The meta-wrapper 401 returns all of the plans (i.e., a composite query execution plan) to the query optimizer 460, which can then estimate execution cost of each plan and choose the cheapest (at process 312). At runtime, the optimizer returns the composite query execution plan to the secondary meta-wrappers (e.g., through the meta-wrapper and an additional query processors) and typically the process will be performed using the query execution plan not the alternatives for the first two union arms. However, since the alternatives are embedded into the plan, decisions can be made dynamically by the various query secondary meta-wrappers as to whether to use the “any” alternatives, and which node to bind “any” to (at process 318). This dynamic binding is especially helpful for the non-local joins because the data has to be transferred across the network anyway as opposed to the current solution of always doing the join at a centralized node, the secondary meta-wrappers can choose the least loaded CPU at that point in query execution when it has to make this decision.

The following is a description of another exemplary implementation of an embodiment of the method and system of the invention. For example, if a meta-wrapper, as described above, receives a query from an optimizer for a join of logical domains D, E that are the direct extensions to joins of more than two logical domains. The following pseudo-code details the join enumeration algorithm of the meta-wrapper (MW).

Plan_request (D [symbol] E):

1. Send domains D, E and any predicates to metadata repository to find that:
(a) D=D₁ U D₂ U . . . Dₙ and E=E₁ U E₂ U . . . Eₘ.
(b) an n×m bipartite graph G as in FIG. 6 where
   (i) each vertex corresponds to a partition of D or of E, and is annotated with the physical node where the partition resides.
   (ii) there is an edge between Dᵢ and Eⱼ iff Dᵢ [symbol] Eⱼ≠ø.

2. PLANS=ø.

3. For each connected component of G whose vertices are all on a single node (e.g., M) do:
(a) Let the nodes of the connected component be Dᵢ₁, Dᵢ₂, . . . and Eⱼ₁, Eⱼ₂, . . .
(b) PLANS=PLANS U (M.plan_request((Dᵢ₁ U Dᵢ₂ U . . . ) [symbol] (Eⱼ₁ U Eⱼ₂ U . . . ))|any.plan_request((Dᵢ₁ U Di₂ U . . . ) [symbol] (Eⱼ₁ U Eⱼ₂ U . . . ));

4. For each connected component of G whose vertices are on the set of nodes {M1, M2 . . . Mk} do:
(a) Let the nodes of the connected component be Dᵢ₁, Dᵢ₂, . . . and Eⱼ₁, Eⱼ₂, . . .
(b) PLANS=PLANS U(M1.plan_request((Dᵢ₁ U Dᵢ₂ U . . . ) [symbol] (Eⱼ₁ U Eⱼ₂ U . . . ))|
   M2.plan_request((Dᵢ₁ U Dᵢ₂ U . . . ) [symbol] (Eⱼ₁ U Eⱼ₂ U . . . ))| . . .
   Mk.plan_request((Dᵢ₁ U Dᵢ₂ U . . . ) ∞ (Eⱼ₁ U Eⱼ₂ U . . . ))|
any.plan_request((Dᵢ₁ U Dᵢ₂ U . . . ) ∞ (Eⱼ₁ U Eⱼ₂ U . . . )));

5. Return PLANS;

In step 1 above, MW unravels this join into a join of unions, by contacting the metadata repository as described above. As a result, MW learns about partitions D₁ . . . Dₙ and E₁ . . . Eₘ. It forms a bipartite graph, where there is an edge between partition Dᵢ and Eⱼ if the metadata repository says that Dᵢ z,900 Eⱼ≠ø, based on its knowledge about the data partitioning. For example, if D and E are partitioned identically and on the join column, m=n and there will be exactly m edges, as illustrated in FIG. 6.

MW now identifies the connected components of this bipartite graph and processes each connected component as follows.

In step 3 above, MW tackles connected components that are located on the same node M (e.g., D1, E1 and E2 of FIG. 6 are located on the same node 631). For each such component, MW creates a query plan Q1 that pushes this join to that node M, e.g., “select . . . from (D₂ U D₃) as D, (E₁ U E₂) as E where . . . ”. This plan is analogous to the collocated join used in shared-nothing systems. The key advantage of the method is that the meta-wrapper also creates an alternative query plan Q2 that pushes this join to a different node any. This “any node” is unbound at the optimization time and has a high estimated cost because of the non-local join. The MW estimates the cost for this alternative by sending the SQL to any node other than M. The optimizer will most likely pick Q1 as the winner (i.e., the most efficient order). But the MW embeds the execution descriptor for the loser plan Q2 within Q1. This allows MW to change this decision at run-time. For example, if the join inputs are on a highly overloaded node, MW can ask a grid scheduler at runtime to find a less loaded node to bind any to.

Step 4 generalizes step 3 to handle connected components spread over more than one node, by generating separate alternatives for each of the nodes of interest (i.e., nodes where one or more of the partitions of the connected component reside), and hence, may be useful to reduce data shipping. In the case where the connected component is spread over exactly two nodes, the plan alternatives involving the nodes of interest are exactly the directed joins used in shared nothing systems. Again, the advantage is that MW decides between these alternatives at runtime, and also binds the any node at runtime.

Therefore, disclosed above are embodiments of a method and a system for executing a query in a database management system, where the query comprises an expensive operation (e.g., a join, a sort, etc.) between two or more datasets. If each dataset has multiple partitions that are located at multiple sources, then each of the multiple partitions for each dataset must be unioned prior to completing execution of the query. The method and system use a hybrid scheme for developing a query execution plan to indicate which processes should be pushed down below the unions and which should be pulled up above the unions based on collocation of partitions. Thus, the method exploits collocated partitioning to the extent it is available but does not rely on completely identical partitioning of datasets. The method further embeds the query execution plan and alternatives to the query execution plan into a composite query execution plan and dynamically evaluates the query execution plan and the alternatives to determine the current most efficient query execution plan. The query is then executed, accordingly.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

What is claimed is:

1. A method for executing a query in a database management system having a plurality of data sources, said method comprising:
receiving said query, wherein said query requires performing a process on multiple first partitions of a first dataset and on multiple second partitions of a second dataset; and
developing a query execution plan such that:
if a first partition is collocated with a second partition on a same source that has a query processor adapted to perform said process, then said process is performed by said query processor on said first partition and on said second partition prior to performing unions of said multiple first partitions and a union of said multiple second partitions; and
if an additional first partition is located on a different source from an additional second partition, then said process is performed on said additional first partition and on said additional second partition after performing a union of at least one of said additional first partition with at least one other first partition and said additional second partition with at least one other second partition.

2. The method of claim 1, further comprising developing at least one alternative query execution plan.

3. The method of claim 2, further comprising:
converting said query execution plan and said alternative query execution plan into query language; and
embedding both said query execution plan and said alternative query execution plan into a composite query execution plan

4. The method of claim 3, further comprising:
dynamically evaluating and re-evaluating said composite query execution plan to determine which of said query execution plan and said alternative query execution plan is currently a most efficient plan based on at least one of current estimated time consumptions, current estimated processor costs, current estimated processor loads and current processor availabilities; and
executing said most efficient plan.

5. The method of claim 1, further comprising after said receiving of said query,
accessing a directory comprising said multiple first partitions of said first dataset, said multiple second partitions of said second dataset, and a list of sources where each of said multiple first partitions and each of said multiple second partitions are located; and
determining which of said multiple first partitions and said multiple second partitions are collocated on said same source.

6. The method of claim 1, wherein said process further comprises a process between said first dataset, said second dataset and at least one additional dataset.

7. The method of claim 1, wherein said process further comprises one of a joining process, a sorting process, a hashing process and a grouping-by process.

8. A method of executing a query in a database management system having a plurality of data sources, said method comprising:
receiving said query, wherein said query requires performing a join between multiple first partitions of a first dataset and multiple second partitions of a second dataset; and
developing a query execution plan such that:
if a first partition is collocated with a second partition on a same source that has a query processor adapted to perform said join, then said join is performed between said first partition and said second partition by said query processor prior to performing unions of said multiple first partitions and said multiple second partitions; and
if an additional first partition is located on a different source from an additional second partition, then said join is performed between said additional first partition and said additional second partition after performing a union of at least one of said additional first partition with at least one other first partition and said additional second partition with at least one other second partition.

9. The method of claim 8, further comprising developing at least one alternative query execution plan.

10. The method of claim 9, further comprising:
converting said query execution plan and said alternative query execution plan into query language; and
embedding both said query execution plan and said alternative query execution plan into a composite query execution plan

11. The method of claim 10, further comprising:
dynamically evaluating and re-evaluating said composite query execution plan to determine which of said query execution plan and said alternative query execution plan is currently a most efficient plan based on at least one of current estimated time consumptions, current estimated processor costs, current estimated processor loads and current processor availabilities; and
executing said most efficient plan.

12. The method of claim 8, further comprising after said receiving of said query,
accessing a directory comprising said multiple first partitions of said first dataset, said multiple second partitions of said second dataset, and a list of sources where each of said multiple first partitions and each of said multiple second partitions are located; and
determining which of said multiple first partitions and said multiple second partitions are collocated on said same source.

13. A system for executing a query in a database management system having a plurality of data sources, said system comprising:
a primary operator adapted develop a query execution plan for a query that requires performing a process on multiple first partitions of a first dataset and on multiple second partitions of a second dataset such that:
if a first partition is collocated with a second partition on a same source having a query processor adapted to perform said process, then said process is performed between said first partition and said second partition by said query processor prior to performing unions of said multiple first partitions and said multiple second partitions; and
if an additional first partition is located on a different source from an additional second partition, then said process is performed between said additional first partition and said additional second partition after performing a union between at least one of said additional first partition with at least one other first partition and said additional second partition with at least one other second partition;
an additional query processor in communication with said primary operator and adapted to perform said process; and
a secondary operator in communication with said additional query processor and a plurality of sources for said first dataset and adapted to perform a union of said multiple first partitions.

14. The system of claim 13, wherein said primary operator is further adapted to develop at least one alternative query execution plan and to embed said query execution plan and said alternative query execution plan into a composite query execution plan.

15. The system of claim 14, further comprising an optimizer in communication with said primary operator and adapted to evaluate said composite query execution plan to determine which of said query execution plan and said alternative query execution plan is a most efficient plan based on at least one of estimated time consumptions, estimated processor costs, estimated processor loads and estimated processor availabilities.

16. The system of claim 14, wherein said secondary operator is adapted to dynamically evaluate and re-evaluate said composite query execution plan to determine which of said query execution plan and said alternative query execution plan is currently a most efficient plan based on at least one of current estimated time consumptions, current estimated processor costs, current estimated processor loads and current processor availabilities and to perform said union according to said most efficient plan.

17. The system of claim 16, wherein said additional query processor is further adapted to receive a set of unioned first partitions from said at least one secondary operator and to perform said process on said set of unioned first partitions.

18. The system of claim 13, further comprising a directory comprising source locations for each of said multiple first partitions of said first dataset and each of said multiple second partitions of said second dataset, wherein said primary operator is further adapted to access said directory to determine which of said first partitions and said second partitions are collocated on said same source.

19. The system of claim 13, wherein said query processor of said same source comprises a federated query processor.

20. A program storage device readable by a computer, tangibly embodying a program of instructions executable by said computer to perform a method of executing a query in a database management system having a plurality of data sources, said method comprising:
receiving said query, wherein said query requires performing a process on multiple first partitions of a first dataset and on multiple second partitions of a second dataset; and
developing a query execution plan such that:
if a first partition is collocated with a second partition on a same source that has a query processor adapted to perform said process, then said process is performed on said first partition and on said second partition by said query processor, prior to performing unions of said multiple first partitions and said multiple second partitions; and
if an additional first partition is located on a different source from an additional second partition, then said process is performed on said additional first partition and on said additional second partition after performing a union of at least one of said additional first partition with at least one other first partition and said additional second partition with at least one other second partition.
